(19) United States
(12) Patent Application Publication
(10) Pub. No.: US 2021/0028441 A1
(43) Pub. Date: Jan. 28, 2021

(54) NEGATIVE ELECTRODE MATERIAL FOR LITHIUM ION SECONDARY BATTERY, NEGATIVE ELECTRODE MATERIAL SLURRY FOR LITHIUM ION SECONDARY BATTERY, NEGATIVE ELECTRODE FOR LITHIUM ION SECONDARY BATTERY, AND LITHIUM ION SECONDARY BATTERY

(71) Applicant: HITACHI CHEMICAL COMPANY, LTD., Tokyo (JP)

(72) Inventors: Hideyuki TSUCHIYA, Chiyoda-ku, Tokyo (JP); Takeshi MASAYOSHI, Chiyoda-ku, Tokyo (JP); Manami HIRAGA, Chiyoda-ku, Tokyo (JP); Takashi SAKAMOTO, Chiyoda-ku, Tokyo (JP)

(73) Assignee: HITACHI CHEMICAL COMPANY, LTD., Tokyo (JP)

(21) Appl. No.: 17/042,177

(22) PCT Filed: Mar. 28, 2018
(86) PCT No.: PCT/JP2018/012984

§ 371 Date: Sep. 27, 2020

(51) Int. Cl. H01M 4/133; H01M 4/66; H01M 4/62; H01M 10/0525

(52) U.S. Cl. CPC H01M 4/133; H01M 4/661; H01M 2004/027; H01M 10/0525; H01M 4/622

(57) ABSTRACT

A negative electrode material for lithium ion secondary batteries has an oil absorption capacity of 50 ml/100 g or more, and a post-pressurization density of 1.70 g/cm³ or more.

### TECHNICAL FIELD

The present invention relates to a negative electrode material for lithium ion secondary batteries, a negative electrode material slurry for lithium ion secondary batteries, a negative electrode for lithium ion secondary batteries, and a lithium ion secondary battery.

### BACKGROUND ART

Because lithium ion secondary batteries have a higher energy density than other secondary batteries such as nickel-cadmium batteries, nickel-hydride batteries, and lead-acid batteries, they are widely used as power sources for portable electrical appliances such as laptop computers and mobile phones. Furthermore, use of lithium ion secondary batteries has significantly expanded not only for relatively small electrical appliances but also for electric vehicles, power sources for power storage, and the like.

In accordance with the diversification of usage applications of lithium ion secondary batteries, further densification of negative electrodes is required to meet demands for smaller size, higher capacity, higher input/output, cost reduction, and the like for lithium ion secondary batteries. In particular, because a lithium ion secondary battery used for an electric vehicle or a power source for power storage is large in size, and a total energy is extremely large, it is difficult to realize compatibility of ensuring safety and reduction in space, and therefore there is high demand for measures for this.

Graphite particles such as natural graphite, which are widely used as a negative electrode material for lithium ion secondary batteries, have a flat shape, and therefore they have a low bulk density when used for negative electrodes. In addition, when a negative electrode produced using these particles is pressed down for densification, there is a problem in which the particles tend to be oriented along a direction parallel to a current collector surface, which reduces permeability of an electrolyte solution from an electrode surface side to a current collector side. Accordingly, a carbon material (spheroidal graphite) in which flat graphite particles are spheroidized to increase a density has been used for a negative electrode material that can handle densification of lithium ion secondary batteries (refer to, for example, Patent Literature 1).

### CITATION LIST

### Patent Literature

[Patent Literature 1]

Japanese Patent Laid-Open No. 2004-196609

### SUMMARY OF INVENTION

### Technical Problem

Because spheroidal graphite is densified in a process of spheroidizing flat graphite particles, a high-density negative electrode can be manufactured by using it. Meanwhile, it was revealed by examination of the inventors of the present invention that, when a negative electrode produced by using spheroidal graphite is further pressed, the charge and discharge efficiency of a battery formed of this negative electrode may be reduced. As the reason for this, it is thought that application of a pressing pressure causes cracks in the spheroidal graphite or an amorphous carbon layer covering the spheroidal graphite, which increases the number of active sites for side reactions. Accordingly, there is a demand for the development of a negative electrode in which the number of unnecessary reaction active sites due to crushing of negative electrode particles does not increase even when a negative electrode having a high capacity and coated with particles is densified.

Because a level of densification required for negative electrodes has tended to increase in recent years, it is expected that a pressing pressure will further increase, and technology that can inhibit deterioration of battery performance such as charge and discharge efficiency while pursuing densification of negative electrodes is becoming more important. Furthermore, there is a demand for further improvement of the life characteristics of lithium ion secondary batteries (inhibition of increase in irreversible capacity) against the backdrop of expanding demand for automotive use.

In view of the above circumstances, an objective of the present invention is to provide a negative electrode material for lithium ion secondary batteries, a negative electrode material slurry for lithium ion secondary batteries, a negative electrode for lithium ion secondary batteries, and a lithium ion secondary battery, which enable compatibility of densification and maintenance of charge and discharge efficiency and inhibit an increase in irreversible capacity.

### Solution to Problem

Specific means for achieving the above-mentioned objective include the following aspects.

<1> A negative electrode material for lithium ion secondary batteries, in which an oil absorption capacity is 50 ml/100 g or more, and a post-pressurization density is 1.70 g/cm³ or more.

<2> The negative electrode material for lithium ion secondary batteries according to <1>, in which the oil absorption capacity is 95 ml/100 g or less.

<3> The negative electrode material for lithium ion secondary batteries according to <1> or <2>, in which the post-pressurization density is 1.98 g/cm³ or less.

<4> The negative electrode material for lithium ion secondary batteries according to any one of <1> to <3>, in which a specific surface area is 1.5 m²/g to 8.0 m²/g.

<5> The negative electrode material for lithium ion secondary batteries according to any one of <1> to <4>, in which a degree of circularity is 0.85 to 0.95.

<6> The negative electrode material for lithium ion secondary batteries according to any one of <1> to <5>, in which an R value from Raman measurement is 0.03 to 0.20.

<7> The negative electrode material for lithium ion secondary batteries according to any one of <1> to <6>, in which a tap density is 0.7 g/cm³ to 1.0 g/cm³.

<8> The negative electrode material for lithium ion secondary batteries according to any one of <1> to <7>, including a plurality of flat graphite particles in a state of being aggregated or bonded such that main surfaces thereof are not parallel.

<9> A negative electrode material slurry for lithium ion secondary batteries, including: the negative electrode material for lithium ion secondary batteries according to any one of <1> to <8>; an organic binding material; and a solvent.

<10> A negative electrode for lithium ion secondary batteries, including: a current collector; and a negative electrode material layer which contains the negative electrode material for lithium ion secondary batteries according to any one of <1> to <8> and is formed on the current collector.

<11> A lithium ion secondary battery including: a positive electrode; an electrolyte; and the negative electrode for lithium ion secondary batteries according to <10>.

### Advantageous Effects of Invention

According to the present invention, a negative electrode material for lithium ion secondary batteries, a negative electrode material slurry for lithium ion secondary batteries, a negative electrode for lithium ion secondary batteries, and a lithium ion secondary battery, which enable compatibility of densification and maintenance of charge and discharge efficiency and inhibit an increase in irreversible capacity, are provided.

### BRIEF DESCRIPTION OF DRAWINGS

FIG. 1 is a schematic cross-sectional view showing a configuration of an apparatus used for measuring a post-pressurization density.

### DESCRIPTION OF EMBODIMENTS

Hereinafter, embodiments for carrying out the present invention will be described in detail. However, the present invention is not limited to the following embodiments. In the following embodiments, constituent elements (including element steps and the like) are not essential unless otherwise specified except for a case in which they are considered clearly necessary in principle. The same applies to numerical values and a range thereof, which do not limit the present invention.

In the present disclosure, the term “step” means not only a step independent from other steps, but also a step that is not clearly distinguished from other steps as long as the purpose of the step is achieved.

In the present disclosure, a numerical value range expressed using “to” includes numerical values before and after “to” as a minimum value and a maximum value.

In stepwise numerical value ranges stated in the present disclosure, the upper limit value or the lower limit value stated in one numerical value range may be replaced with the upper limit value or the lower limit value of another stated stepwise numerical value range. In addition, in a numerical value range described in the present disclosure, the upper limit value or the lower limit value of this numerical value range may be replaced with values shown in Examples.

Regarding respective components in the present disclosure, a plurality of substances corresponding thereto may be contained. In a case where a plurality of substances corresponding to respective components is present in a composition, a proportional content or content of each component means a total proportional content or content of the plurality of substances corresponding thereto present in the composition unless otherwise specified.

In the present disclosure, a plurality of types of particle corresponding to each component may be included. In a case where a plurality of types of particle corresponding to the respective components is present in the composition, a particle size of each component means a value of a mixture of the plurality of types of particle corresponding thereto present in the composition unless otherwise specified.

In the present disclosure, the term “layer” or “film” refers to not only a case of being formed over the entire region but also a case of being formed only in a part of the region when observing the region in which the layer or film is present.

<Negative Electrode Material for Lithium Ion Secondary Batteries>

A negative electrode material for lithium ion secondary batteries of the present disclosure (hereinafter, also simply referred to as a negative electrode material) has an oil absorption capacity of 50 ml/100 g or more and a post-pressurization density of 1.70 g/cm³ or more.

According to the examination conducted by the inventors of the present invention, it was found that densification and maintenance of charge and discharge efficiency of a lithium ion secondary battery can be compatible, and an increase in irreversible capacity is inhibited in a negative electrode material having an oil absorption capacity of 50 ml/100 g or more and a post-pressurization density of 1.70 g/cm³ or more, as compared with a negative electrode material that does not satisfy at least one of these conditions.

An oil absorption capacity of the negative electrode material is an index of a proportion of voids in the negative electrode material, and as an oil absorption capacity becomes larger, a proportion of voids become larger, which is considered to be unsuitable for a negative electrode material for high-density lithium ion secondary batteries. However, it was found that a charge and discharge efficiency was excellent in the case of densification, and an increase in irreversible capacity was inhibited in a negative electrode produced using the negative electrode material of the present disclosure, as compared with a negative electrode produced using a negative electrode material such as spheroidal graphite having a smaller oil absorption capacity (that is, a higher density). The reason for this is not clear, but it is thought that disruption, cracks, or the like of the negative electrode material, which are associated with a densification treatment (pressing), are made unlikely to occur due to the presence of appropriate voids in a negative electrode material, and thereby generation of side reactions is inhibited.

The negative electrode material of the present disclosure has an oil absorption capacity of 50 ml/100 g or more and a density (post-pressurization density) of 1.70 g/cm³ or more when pressurized under predetermined conditions, and therefore it can be used as a suitable material for a high-density electrode. When the negative electrode material of the present disclosure has an oil absorption capacity and a post-pressurization density within specific ranges, densification and favorable charge and discharge efficiency are compatible in a lithium ion secondary battery formed of this negative electrode material.

A state after pressing the negative electrode material of the present disclosure under predetermined conditions is not particularly limited, and it may or may not form an agglomerate having a pelletized shape or the like.

(Oil Absorption Capacity)

The oil absorption capacity of the negative electrode material is an index showing a proportion of voids in the negative electrode material, and it can be said that the larger the oil absorption capacity, the greater the proportion of voids in the negative electrode material.

In the present disclosure, when the oil absorption capacity of the negative electrode material is 50 ml/100 g or more, a charge and discharge efficiency of the negative electrode tends to be favorably maintained. The oil absorption capacity of the negative electrode material is not particularly limited as long as it is 50 ml/100 g or more, but it may be 55 ml/100 g or more, or 60 ml/100 g or more.

The upper limit of the oil absorption capacity of the negative electrode material is not particularly limited, but it may be 95 ml/100 g or less, 85 ml/100 g or less, or 75 ml/100 g or less from the viewpoint of the balance with conditions for a post-pressurization density.

In the present disclosure, an oil absorption capacity of the negative electrode material can be measured using linseed oil (manufactured by Kanto Chemical Co., Inc.) instead of using dibutyl phthalate (DBP) as a reagent liquid described in JIS K 6217-4: 2008 “Carbon Black for Rubber-Fundamental Characteristics-Part 4: Determination of Oil Absorption Capacity.” Specifically, linseed oil is titrated into a target powder with a constant speed buret, and the change in viscosity characteristics is measured from a torque detector. An amount of linseed oil added per unit mass of the target powder, which corresponds to 70% of the generated maximum torque, is used as an oil absorption capacity (ml/100 g). As a measuring device, for example, it is possible to use an absorption amount measuring device manufactured by ASAHISOUKEN CORPORATION.

(Post-Pressurization Density)

A post-pressurization density of the negative electrode material is a density reached when a pressure is applied to the negative electrode material under predetermined conditions, and it can be said that the larger this value, the easier the densification of the negative electrode.

In the present disclosure, since a post-pressurization density of the negative electrode is 1.70 g/cm³ or more, densification of the negative electrode produced by using this negative electrode can be sufficiently performed. A post-pressurization density of the negative electrode material is not particularly limited as long as it is 1.70 g/cm³ or more, but it may be 1.72 g/cm³ or more, or 1.80 g/cm³ or more.

An electrode density when a battery is actually produced using the negative electrode material is not particularly limited. Because the negative electrode material of the present disclosure has excellent press resistance, a deterioration of characteristics tends to be inhibited even in an electrode in which a density has been adjusted to a low value (for example, about 1.40 g/cm³).

The upper limit of a post-pressurization density of the negative electrode material is not particularly limited, but it may be 1.98 g/cm³ or less, 1.90 g/cm³ or less, or 1.80 g/cm³ or less from the viewpoint of the balance with conditions for an oil absorption capacity.

In the present disclosure, a post-pressurization density of the negative electrode material can be measured by the following method.

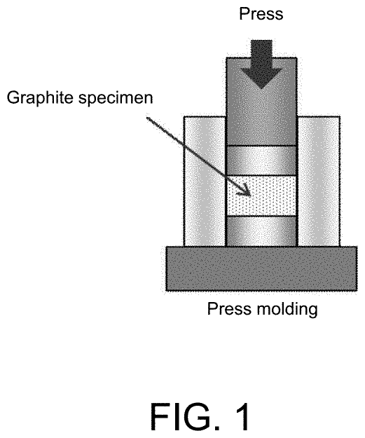

A die having a diameter of 13 mm (bottom area: 1.327 cm²) is filled with 1.2 g of a sample, and compressed at a constant speed of 10 mm/min using an AUTOGRAPH (manufactured by Shimadzu Corporation) equipped with a load cell configured as shown in FIG. 1. After maintaining for 30 minutes with a pressing force of 1 t (contact pressure: 754 kg/cm²), the pressure is released to measure a thickness after 5 minutes. A volume is calculated using the measured thickness, and a post-pressurization density is calculated.

(Specific Surface Area)

The negative electrode material may have a specific surface area of 1.5 m²/g to 8.0 m²/g, or 2.0 m²/g to 7.0 m²/g.

A specific surface area of the negative electrode material is an index showing an area of an interface between the negative electrode material and the electrolytic solution. When a specific surface area of the negative electrode material is 8.0 m²/g or less, an area of an interface between the negative electrode material and the electrolytic solution does not become excessively large, and therefore, an increase in a reaction field of a decomposition reaction of the electrolytic solution may be inhibited, thereby inhibiting gas generation, and the initial charge and discharge efficiency may become favorable. When a value of the specific surface area is 1.5 m²/g or more, a current density per unit area does not increase rapidly and a load is reduced, and therefore, a charge and discharge efficiency, charge acceptability, rapid charge and discharge characteristics, and the like tend to be improved.

The specific surface area of the negative electrode material can be measured by a BET method (nitrogen gas adsorption method). Specifically, nitrogen gas is adsorbed on a sample using a gas adsorption device (ASAP2010, manufactured by Shimadzu Corporation), the sample being obtained by filling a measurement cell with a negative electrode material and subjecting it to a heat pretreatment at 200° C. for 10 hours or longer under vacuum degassing. BET analysis is performed on the obtained sample by a 5-point method to calculate a specific surface area.

A specific surface area of the negative electrode material can be set to a desired range by, for example, adjusting an average particle size (as an average particle size becomes smaller, a specific surface area tends to become larger, and as an average particle size becomes larger, a specific surface area tends to become smaller).

(Degree of Circularity)

The negative electrode material may have a degree of circularity of 0.85 to 0.95 or 0.80 to 0.90 as measured by a flow type particle analyzer. When a degree of circularity of the negative electrode material is 0.85 or more, an electrode plate orientation when used as a negative electrode tends to be low and input/output characteristics tend to be favorable. When a degree of circularity of the negative electrode material is 0.95 or less, a sufficient contact area between particles is secured and a deterioration of electric conductivity tends to be inhibited.

A degree of circularity of the negative electrode material can be measured by the following method. 5 ml of an aqueous solution including a surfactant (trade name: Liponol T/15, manufactured by Lion Corporation) at a concentration of 0.2% by mass is placed in a 10 ml test tube, and a measurement sample is added thereto such that a particle concentration becomes 10,000/μl to 30,000/μl. Next, the test tube is stirred with a vortex mixer (manufactured by Corning Co., Ltd.) at a rotation speed of 2,000 times per minute (rpm) for 1 minute, and immediately thereafter, a degree of circularity is measured using a wet flow type particle size/shape analyzer (for example, FPIA-3000 manufactured by Malvern Instruments) under the following measurement conditions.

Measuring environment: 25° C.±3

Measurement mode: HPF

Count method: Total count

Number of valid analyses: 10,000

Sheath liquid: Particle sheath

Objective lens: 10 times

(R value)

An R value from Raman measurement of the negative electrode material (hereinafter, also referred to as an R value) may be 0.03 to 0.20 or 0.05 to 0.15.

When an R value of the negative electrode material is 0.03 or more, an edge for Li to be inserted into the graphite crystal is left, charge characteristics are less likely to deteriorate, and thereby generation of Li dendrites tends to be inhibited. When an R value is 0.20 or less, an excessive number of edges with high reaction activity does not remain, an amount of decomposition reaction of an electrolytic solution is reduced, an amount of generated gas is reduced, and thereby the lifespan tends to become longer.

In the present disclosure, an R value of the negative electrode material is an intensity ratio (IB/IA) of a maximum peak intensity IA near 1,580 cm⁻¹ to a maximum peak intensity IB near 1,360 cm⁻¹ in the Raman spectrum obtained in the Raman measurement described below.

Regarding Raman measurement, measurement is performed by irradiating a sample plate, on which a negative electrode material for lithium ion secondary batteries, or an electrode obtained by applying the negative electrode material for lithium ion secondary batteries onto a current collector and pressurizing is set to be flat, with an argon laser beam using a Raman spectroscope “laser Raman spectrophotometer (model number: NRS-1000, manufactured by JASCO Corporation). The measurement conditions are as follows.

Argon laser light wavelength: 532 nm

Wavenumber resolution: 2.56 cm⁻¹

Measuring range: 1,180 cm⁻¹ to 1,730 cm⁻¹

Peak research: Background removal

(Tap Density)

A tap density of the negative electrode material may be 0.7 g/cm³ to 1.0 g/cm³ or 0.8 g/cm³ to 0.9 g/cm³. When a tap density of the negative electrode material is 0.7 g/cm³ or more, a binder necessary for forming an electrode plate tends to adhere to a surface of particles, and problems such as peeling off at a current collector interface tend not to occur easily. When a tap density is 1.0 g/cm³ or less, an amount of space inside particles increases, and flexibility during pressing tends to increase. A high tap density means that particles have a high density and a small number of internal pores, and therefore an oil absorption capacity tends to become small in general.

In the present disclosure, a tap density of the negative electrode material is calculated as a density obtained after putting 100 ml of a negative electrode material for lithium ion secondary batteries into a measuring cylinder, and tapping (dropping the measuring cylinder from a predetermined height) until a density becomes constant, using a packing density measuring device (KRS-406, manufactured by Kuramochi Scientific Instruments Co., Ltd.).

The negative electrode material is not particularly limited as long as it satisfies the above-mentioned conditions, but it is preferably a carbon material. When the negative electrode material is a carbon material, it may consist of only a carbon material or may contain a different element. Examples of carbon materials include natural graphite such as vein graphite, amorphous graphite, and spheroidal graphite, graphite such as artificial graphite, amorphous carbon, carbon black, fibrous carbon, nanocarbon, and the like. A carbon material contained in the negative electrode material may be only one kind or a combination of two or more kinds.

Furthermore, the negative electrode material may contain particles containing an element capable of occluding and releasing lithium ions. An element capable of occluding and releasing lithium ions is not particularly limited, and examples thereof include Si, Sn, Ge, In, and the like.

The negative electrode material may include particles (hereinafter, also referred to as graphite secondary particles) in a state in which a plurality of flat graphite particles is aggregated or bonded such that main surfaces thereof are not parallel. When the negative electrode material is in a state of including secondary graphite particles, densification and maintenance of charge and discharge efficiency are easily made to be compatible, as compared to a case in which the negative electrode material is spheroidal graphite. It is thought that the reason for this is because the influence of a pressure applied when pressing on individual graphite particles is reduced due to voids present between a plurality of flat graphite particles constituting graphite secondary particles, and thereby disruption of the graphite particles, generation of cracks, and the like are unlikely to occur.

The flat graphite particles are non-spheroidal graphite particles having anisotropy in shape. Examples of flat graphite particles include graphite particles having a vein-like shape, a flake-like shape, a partially lumpy shape, or the like.

An aspect ratio represented by A/B of the flat graphite particles is preferably, for example, 1.2 to 20, and is more preferably 1.3 to 10 when A is a length in a major axis direction and B is a length in a minor axis direction. When the aspect ratio is 1.2 or more, a contact area between particles increases, and electric conductivity tends to be further improved. When the aspect ratio is 20 or less, input and output characteristics such as rapid charge and discharge characteristics of a lithium ion secondary battery tend to be further improved.

The aspect ratio is obtained by observing graphite particles with a microscope, arbitrarily selecting 100 graphite particles, measuring A/B of each of the particles, and obtaining an arithmetic mean value of the measured values. In observing the aspect ratio, the length A in the major axis direction and the length B in the minor axis direction are measured as follows. That is, in a projected image of graphite particles is observed using a microscope, two parallel tangent lines circumscribing the outer periphery of the graphite particles, which are a tangent line a1 and a tangent line a2 having a maximum distance therebetween, are selected, and a distance between the tangent line a1 and the tangent line a2 is defined as the length A in the major axis direction. In addition, two parallel tangent lines circumscribing the outer periphery of the graphite particles, which are a tangent line b1 and a tangent line b2 having a minimum distance, are selected, and a distance between the tangent line b1 and the tangent line b2 is defined as the length B in the minor axis direction.

In the present disclosure, the sentence “main surfaces thereof are not parallel” regarding a plurality of flat graphite particles means that the largest cross-sectional surface (the main surface) of the plurality of the flat graphite particles is not aligned in a certain direction. Whether or not the main surfaces of the plurality of flat graphite particles are not parallel to each other can be confirmed by microscopic observation. When a plurality of flat graphite particles is aggregated or bonded in a state where the main surfaces thereof are not parallel to each other, an increase in regularity of orientation of the main surfaces of the flat graphite particles in the negative electrode is inhibited, expansion of the negative electrode due to charging is inhibited, and thereby cycle characteristics of a lithium ion secondary battery tend to be improved.

Graphite secondary particles may partially include a structure in which a plurality of flat graphite particles is aggregated or bonded such that main surfaces thereof are parallel to each other.

In the present disclosure, the phrase “state of being aggregated or bonded” regarding the plurality of flat graphite particles means a state in which two or more flat graphite particles are aggregated or bonded. The term “bonded” means a state in which particles are chemically bonded to each other directly or via a carbon substance. The term “aggregated” means a state in which particles are not chemically bonded to each other, but a shape of an aggregate is maintained due to a shape or the like of an organic binder or particles. The flat graphite particles may be aggregated or bonded via a carbon substance. Examples of carbon substances include a carbon substance obtained by heat-treating an organic binding material containing at least one of a cyclic molecular structure or a chain molecular structure such as tar and pitch. The carbon substances are not particularly limited, and examples thereof include amorphous carbon, graphite, and the like. However, from the viewpoint of mechanical strength, the flat graphite particles are preferably bonded by graphite carbon graphitized at a high temperature of 2,000° C. or higher at which crystallinity starts to develop rapidly, rather than hard amorphous carbon heated to around 1,000° C.

An average particle size of the flat graphite particles is, for example, preferably 1 μm to 50 μm, more preferably 1 μm to 25 μm, and even more preferably 1 μm to 15 μm, from the viewpoint of easy aggregation or bonding. The average particle size of the flat graphite particles can be measured by a laser diffraction particle size distribution measuring device, and it is a particle size (D50) at 50% in cumulative volume-based particle size distribution from the small diameter end.

The flat graphite particles and a raw material thereof are not particularly limited, and examples thereof include artificial graphite, vein natural graphite, flake natural graphite, coke, resin, tar, pitch, and the like. Among them, graphite obtained from artificial graphite, natural graphite, or coke has high crystallinity and becomes soft particles, and therefore in this case a density of the negative electrode tends to be easily increased.

The negative electrode material may include spheroidal graphite particles. When the negative electrode material contains spheroidal graphite particles, the spheroidal graphite particles themselves have a high density, and therefore a pressing pressure required to obtain a desired electrode density tends to be reduced.

Examples of spheroidal graphite particles include spheroidal artificial graphite, spheroidal natural graphite, and the like. From the viewpoint of densification of the negative electrode, the spheroidal graphite particles are preferably high-density graphite particles. Specifically, spheroidal natural graphite that has been subjected to a particle spheroidizing treatment to obtain a high tap density is preferable. Spheroidal natural graphite has a characteristic in which an electrode having strong peeling strength is unlikely to be peeled off from a current collector even when the electrode is pressed down with a strong force, and therefore, by using this for a negative electrode material, a negative electrode material having stronger peel strength tends to be obtained. The negative electrode material capable of exhibiting stronger peel strength can reduce an amount of a binder in an electrode plate, and since the binder serves as a charge and discharge resistance component, input/output characteristics tend to be improved.

When the negative electrode material includes the above-described graphite secondary particles and spheroidal graphite particles, a proportion between the two is not particularly limited, and it can be set according to a desired electrode density, desired pressurization conditions during pressing, desired battery characteristics, and the like.

An average particle size of the spheroidal graphite particles can be adjusted according to an application amount (thickness) of the electrode, but it is preferably 1 μm to 50 μm, more preferably 1 μm to 25 μm, and even more preferably 1 μm to 15 μm. The average particle size of the spheroidal graphite particles can be measured by a laser diffraction particle size distribution measuring device as in the case of the flat graphite particles, and it is a particle size (D50) at 50% in a cumulative volume-based particle size distribution from the small diameter end.

Examples of cases in which the negative electrode material contains graphite secondary particles and spheroidal graphite particles include a state in which the graphite secondary particles and the spheroidal graphite particles are mixed, a state in which the graphite secondary particles and the spheroidal graphite particles are bonded to each other (hereinafter, also referred to as composite particles), and the like. Examples of composite particles include particles in a state in which graphite secondary particles and spheroidal graphite particles are bonded via an organic carbide.

In the spheroidal graphite with a high degree of circularity, a particle thickness (that is, a depth per spheroidal graphite particle in a direction of a current collector as the particles are pressed down from an electrode surface in the electrode) is almost unchanged even when particles rotate due to a pressure applied by pressing. Meanwhile, flat primary particles rotate to release a pressure in pressing, a thickness (depth) in the direction of the current collector becomes smaller, and therefore a density near the electrode surface becomes higher than that near the current collector in some cases. The inventors of the present invention have found that suitable incorporation of spheroidal graphite having a high degree of circularity into the negative electrode material has a function of inhibiting uneven density in a direction from an electrode surface to a current collector when pressing the electrode. By inhibiting an uneven density, an electrolytic solution on the electrode surface is evenly present around particles, and thereby an effect of improving load characteristics such as rapid charging and discharging can be obtained. Meanwhile, as a proportional content of spheroidal graphite in the negative electrode material increases, a post-pressurization density tends to decrease and an oil absorption capacity tends to decrease at the same time. Therefore, an amount of spheroidal graphite is preferably set in consideration of a desired post-pressurization density and an oil supply amount.

The negative electrode material may be in a state in which amorphous carbon (including low crystalline carbon) is disposed on at least a part of a surface of graphite particles. When amorphous carbon is disposed on at least a part of the surface of the graphite particles, input/output characteristics such as rapid charge and discharge characteristics tend to be further improved when a lithium ion secondary battery is configured.

An average particle size of the negative electrode material may be, for example, 5 μm to 40 μm, 10 μm to 30 μm, or 10 μm to 25 μm. An average particle size of the negative electrode material may be, for example, a volume average particle size measured by a laser diffraction/light scattering method. Specifically, it may be a particle size (D50) at 50% in a cumulative volume-based particle size distribution from the small diameter end measured using a laser diffraction particle size distribution measuring device.

Examples of methods of measuring an average particle size when an electrode (negative electrode) is manufactured using a negative electrode material include a method in which a sample electrode is produced, and this electrode is embedded in epoxy resin and then mirror-polished to observe an electrode cross-sectional surface with a scanning electron microscope (for example, “VE-7800” manufactured by KEYENCE CORPORATION), a method in which an electrode cross-sectional surface is produced using an ion milling device (for example, “E-3500” manufactured by Hitachi High-Technology Co., Ltd.) and measured with a scanning electron microscope (for example, “VE-7800” manufactured by KEYENCE CORPORATION), and the like. The average particle size in this case is a median value of 100 particle sizes arbitrarily selected from the observed particles.

The sample electrode can be produced by, for example, producing a dispersion liquid in which water is added such that a viscosity of a mixture at 25° C. is 1,500 mPa·s to 2500 mPa·s, applying the dispersion liquid onto a copper foil having a thickness of 10 μm such that a thickness (at the time of application) of the dispersion liquid becomes about 70 μm, and thereafter drying it at 120° C. for 1 hour, in which a mixture of 98 parts by mass of a negative electrode material, 1 part by mass of styrene-butadiene resin as a binder, and 1 part by mass of carboxymethyl cellulose as a thickening material is used as a solid content.

<Production Method for Negative Electrode Material for Lithium Ion Secondary Batteries>

A production method for a negative electrode material for lithium ion secondary batteries (hereinafter, also referred to as a production method for a negative electrode material) includes a step (a) of obtaining a mixture containing a graphitizable aggregate or graphite and a graphitizable binder; and a step (b) of graphitizing the mixture.

In the step (a), the graphitizable aggregate or graphite and the graphitizable binder are mixed to obtain the mixture. If necessary, a graphitization catalyst, a fluidity imparting agent, and the like may be added.

Examples of graphitizable aggregates include coke such as fluid coke, needle coke, and mosaic coke. Furthermore, aggregates that are already graphite such as natural graphite and artificial graphite may be used. The graphitizable aggregate or graphite is preferably a powder. A particle size of the graphitizable aggregate or graphite is preferably smaller than a particle size of the above-described flat graphite particles.

Examples of graphitizable binders include coal-based binders, petroleum-based binders, or artificial pitches and tars, thermoplastic resins, thermosetting resins, and the like.

A content of the graphitizable binder may be 5 to 80 parts by mass, 10 to 80 parts by mass, or 15 parts by mass to 80 parts by mass with respect to 100 parts by mass of the graphitizable aggregate or graphite.

Examples of graphitization catalysts include substances having a graphitization catalyst action such as silicon, iron, nickel, titanium, boron, vanadium, and aluminum; carbides, oxides, nitrides, and mica clay minerals of these substances; and the like.

When the graphitization catalyst is added, an amount of the graphitization catalyst is not particularly limited, but it may be 1 part by mass to 50 parts by mass with respect to 100 parts by mass of a total amount of the graphitizable aggregate or graphite and the graphitizable binder. When an amount of the graphitization catalyst is 1 part by mass or more, crystal development of graphite particles tends to be favorable, and a charge and discharge capacity tends to be favorable. On the other hand, when an amount of the graphitization catalyst is 50 parts by mass or less, workability tends to be favorable. In addition, it is preferable from the viewpoint of energy cost, because graphitization can be performed at a lower temperature than in the case where graphitization is performed without adding a graphitization catalyst.

When a graphitization catalyst is not added to a mixture, for example, the mixture can be graphitized by maintaining it at a high temperature for a long time. From the viewpoint of sufficient crystal development and obtaining a sufficient capacity, a temperature is preferably maintained at 2,500° C. or higher, and is more preferably maintained at 3,000° C. or higher.

From the viewpoint of facilitating molding of a mixture, the mixture preferably contains a fluidity imparting agent. In particular, when the mixture is molded by extrusion molding, the mixture preferably contains a fluidity imparting agent in order to mold the mixture while the mixture flows. Furthermore, incorporation of a fluidity imparting agent in the mixture leads to a reduction in an amount of graphitizable binder, and therefore, improvement in battery characteristics such as initial charge and discharge efficiency of the negative electrode material can be expected.

The type of fluidity imparting agent is not particularly limited. Specific examples thereof include hydrocarbons such as liquid paraffin, paraffin wax, and polyethylene wax; fatty acids such as stearic acid, oleic acid, erucic acid, and 12-hydroxystearic acid; fatty acid metal salts such as zinc stearate, lead stearate, aluminum stearate, calcium stearate, and magnesium stearate; fatty acid amides such as stearic acid amides, oleic acid amides, erucic acid amides, methylenebisstearic acid amides, and ethylenebisstearic acid amides; fatty acid esters such as stearic acid monoglyceride, stearyl stearate, and hardened oils; higher alcohols such as stearyl alcohol; and the like. Among them, fatty acids are preferable, and stearic acid is more preferable from the viewpoint that they are less likely to affect the performance of the negative electrode material, are easily handled because they are solid at room temperature, are uniformly dispersed and dissolve in the step (a), disappear in a process before a graphitization treatment, and are inexpensive.

When the mixture contains a fluidity imparting agent, an amount thereof is not particularly limited. For example, a content of the fluidity imparting agent with respect to a total amount of the mixture may be 0.1% by mass to 20% by mass, 0.5% by mass to 10% by mass, or 0.5% by mass to 5% by mass.

A method of mixing the graphitizable aggregate or graphite with the graphitizable binder is not particularly limited. For example, mixing can be performed using a kneader or the like. The mixing may be performed at a temperature equal to or higher than a softening point of the binder. Specifically, when the graphitizable binder is pitch, tar, or the like, a temperature may be 50° C. to 300° C., and when the graphitizable binder is a thermosetting resin, a temperature may be 20° C. to 100° C.

In the step (b), the mixture obtained in the step (a) is graphitized. Accordingly, graphitizable components in the mixture are graphitized. Graphitization is preferably performed in an atmosphere in which the mixture is unlikely to oxidize, and examples thereof include a method of heating in a nitrogen atmosphere, argon gas, or a vacuum. A temperature during graphitization is not particularly limited as long as it is a temperature at which the graphitizable component can be graphitized. For example, a temperature may be 1,500° C. or higher, 2,000° C. or higher, 2,500° C. or higher, or 2,800° C. or higher. An upper limit of the temperature is not particularly limited, but it may be 3,200° C. or lower, for example. When the temperature is 1,500° C. or higher, crystal change occurs. When the temperature is 2,000° C. or higher, graphite crystal development becomes favorable. When the temperature is 2,500° C. or higher, graphite crystal tends to develop into a high-capacity graphite crystal capable of storing more lithium ions, and an amount of the graphitization catalyst remaining after baking tends to be small, and an increase in an amount of ash tends to be curbed. In both cases, a charge and discharge capacity and cycle characteristics of a battery tend to become favorable. On the other hand, when the temperature during graphitization is 3,200° C. or lower, it is possible to inhibit sublimation of part of the graphite.

The production method of a negative electrode material may include at least one selected from the group consisting of a step (c) of molding a mixture and a step (d) of heat-treating the mixture, between the step (a) and the step (b).

A molding method in the step (c) is not particularly limited. For example, the mixture may be ground and put in a container such as a die. Alternatively, the mixture may be molded by extrusion molding in a state of maintaining its fluidity.

When the mixture is molded, a bulk density is increased, and therefore a packing amount in a graphitization furnace is increased, energy efficiency is increased, and thereby graphitization can be performed with energy saving. Furthermore, when the mixture contains a graphitization catalyst, molding reduces a distance between catalyst particles and graphitizable aggregates. As a result, a graphitization reaction proceeds in a short time, leading to further energy saving, and thereby the environmental load related to production can be reduced. In addition, molding further increases a bulk density, and control is performed such that the distance between particles is reduced, thereby increasing the catalyst utilization efficiency. As a result, loss caused by sublimation of the graphitization catalyst without being used in the graphitization reaction can be reduced.

Development of graphite crystals can be controlled freely by adjusting whether or not to perform molding of the mixture, a bulk density after molding, the type and a content of a graphitization catalyst, a temperature and a time of graphitization, and the like.

The heat treatment of the mixture in the step (d) is preferable from the viewpoint of removing volatile components contained in the mixture and inhibiting gas generation during the graphitization in the step (b). The heat treatment is more preferably performed after the mixture is molded in the step (c). The heat treatment is preferably performed at a temperature at which volatile components contained in the mixture are removed, and it may be performed at, for example, 500° C. to 1,000° C.

The obtained graphitized product may be ground and adjusted in particle size to obtain a desired particle size.

The graphitized product after graphitization and grinding may be subjected to an isotropic pressurization treatment. Examples of isotropic pressurization treatment methods include a method in which a container made of rubber or the like is filled with the graphitized product after grinding, the container is sealed, and then the container is subjected to an isotropic pressurization treatment with a press machine. When the graphitized product that has been subjected to the isotropic pressurization treatment is aggregated and solidified, it can be crushed with a cutter mill or the like and granulated with a sieve or the like.

The method described above is an example of the production method of a negative electrode material. The negative electrode material may be manufactured by methods other than the above-mentioned method.

(Negative Electrode Material Slurry for Lithium Ion Secondary Batteries)

A negative electrode material slurry for lithium ion secondary batteries of the present disclosure (hereinafter, also referred to as a negative electrode material slurry) contains the above-described negative electrode material, an organic binding material, and a solvent.

The organic binding material is not particularly limited. Examples thereof include polymer compounds including styrene-butadiene rubber, and ethylenically unsaturated carboxylic acid esters (methyl (meth)acrylate, ethyl (meth)acrylate, butyl (meth)acrylate, hydroxyethyl (meth)acrylate, and the like) as polymerization components; polymer compounds containing ethylenically unsaturated carboxylic acids (acrylic acid, methacrylic acid, itaconic acid, fumaric acid, maleic acid, and the like) as a polymerization component; and polymer compounds such as polyvinylidene fluoride, polyethylene oxide, polyepichlorohydrin, polyphosphazene, polyacrylonitrile, polyimide, and polyamideimide. In the present disclosure, (meth)acrylate means either or both of methacrylate and acrylate.

The solvent is not particularly limited. Examples thereof include water, an organic solvent, or a mixture thereof As the organic solvent, organic solvents such as N-methylpyrrolidone, dimethylacetamide, dimethylformamide, and γ-butyrolactone are used.

The negative electrode material slurry may contain a thickener for adjusting a viscosity, if necessary. Examples of thickeners include carboxymethyl cellulose, methyl cellulose, hydroxymethyl cellulose, ethyl cellulose, polyvinyl alcohol, polyacrylic acid and salts thereof, oxidized starch, phosphorylated starch, casein, and the like.

The negative electrode material slurry may contain a conductive auxiliary agent, if necessary. Examples of conductive auxiliary agents include carbon black, graphite, graphene, acetylene black, carbon nanotubes, conductive oxides, conductive nitrides, and the like.

(Negative Electrode for Lithium Ion Secondary Batteries)

A negative electrode for lithium ion secondary batteries of the present disclosure (hereinafter, also referred to as a negative electrode) includes a current collector; and a negative electrode material layer which contains the above-described negative electrode material and is formed on the current collector.

A material and a shape of the current collector are not particularly limited. For example, it is possible to use a material such as a strip-shaped foil, a strip-shaped perforating foil, or a strip-shaped mesh made of a metal or alloy such as aluminum, copper, nickel, titanium, and stainless steel. Furthermore, it is also possible to use porous materials such as porous metal (foamed metal) and carbon paper.

A method of forming the negative electrode material layer containing the negative electrode material on the current collector is not particularly limited. For example, it can be carried out by a known method such as a metal mask printing method, an electrostatic coating method, a dip coating method, a spray coating method, a roll coating method, a doctor blade method, a gravure coating method, and a screen printing method. In a case of integrating the negative electrode material layer and the current collector, it can be carried out by a known method such as rolling, pressing, or a combination thereof.

The negative electrode obtained by forming the negative electrode material layer on the current collector may be subjected to a heat treatment. By the heat treatment, a solvent contained in the negative electrode material layer is removed, strength of a binder is increased due to hardening, and adhesiveness between particles and between the particles and the current collector can be improved. The heat treatment may be performed in an inert atmosphere of helium, argon, nitrogen, or the like or in a vacuum atmosphere in order to prevent oxidation of the current collector during the treatment.

The negative electrode may be pressed (pressurization treatment) before the heat treatment. An electrode density can be adjusted by the pressurization treatment. The electrode density may be 1.5 g/cm³ to 1.9 g/cm³, or 1.6 g/cm³ to 1.8 g/cm³. As an electrode density becomes higher, a volume capacity is further increased, and adhesiveness of the negative electrode material layer to the current collector tends to be improved, and cycle characteristics also tend to be improved.

(Lithium Ion Secondary Battery)

A lithium ion secondary battery of the present disclosure includes a positive electrode, an electrolyte, and the above-described negative electrode. The lithium ion secondary battery may include members other than these members as needed. The lithium ion secondary battery can be configured, for example, such that at least the negative electrode and the positive electrode are disposed to face each other with a separator interposed therebetween, and an electrolytic solution containing an electrolyte is injected.

The positive electrode can be obtained by forming a positive electrode layer on a surface of the current collector in the same manner as the negative electrode. As the current collector, it is possible to use a material such as a strip-shaped foil, a strip-shaped perforating foil, or a strip-shaped mesh made of a metal or alloy such as aluminum, titanium, and stainless steel.

A positive electrode material used for the positive electrode layer is not particularly limited. Examples thereof include metal compounds, metal oxides, metal sulfides, and conductive polymer materials which can be doped or intercalated with lithium ions. Furthermore, it is possible to use one or two or more kinds in combination from lithium cobalt oxide (LiCoO₂), lithium nickel oxide (LiNiO₂), lithium manganate (LiMnO₂), and complex oxides thereof (LiCoₓNi_{y}MnO₂, x+y+z=1, 0<x, 0<y; LiNi₂₋ₓMnₓO₄, 0, 0<x<2), lithium manganese spinel (LiMn₂O₄), lithium vanadium compounds, V₂O₅, V₆O₁₃, VO₂, MnO₂, TiO₂, MoV₂O₈, TiS₂, V₂S₅, VS₂, MoS₂, MoS₃, Cr₃O₈, Cr₂O₅, olivine type LiMPO₄ (M: Co, Ni, Mn, Fe), conductive polymers such as polyacetylene, polyaniline, polypyrrole, polythiophene, and polyacene, porous carbon, and the like. Among them, lithium nickel oxide (LiNi02) and a complex oxide thereof (LiCoₓNi_{y}Mn_{z}O₂, x+y+z=1, 0<x, 0<y; LiNi₂₋ₓMnₓO₄, 0<x≤2) have a high capacity, and thus are suitable as positive electrode materials. From the viewpoint of further increasing a capacity, nickel-cobalt-aluminum (NCA) positive electrode material is also suitably used.

Examples of separators include non-woven fabrics containing polyolefins such as polyethylene and polypropylene as a main component, cloth, microporous film, and a combination thereof When the lithium ion secondary battery has a structure in which the positive electrode and the negative electrode are not in contact with each other, it is not necessary to use a separator.

As the electrolytic solution, it is possible to use so-called organic electrolyte solutions in which lithium salts such as LiClO₄, LiPF₆, LiAsF₆, LiBF₄, and LiSO₃CF₃ are dissolved a non-aqueous solvent containing a single component or a mixture of two or more components such as ethylene carbonate, propylene carbonate, butylene carbonate, vinylene carbonate, fluoroethylene carbonate, cyclopentanone, sulfolane, 3-methylsulfolane, 2,4-dimethylsulfolane, 3-methyl-1,3-oxazolidin-2-one, γ-butyrolactone, dimethyl carbonate, diethyl carbonate, ethyl methyl carbonate, methyl propyl carbonate, butyl methyl carbonate, ethyl propyl carbonate, butyl ethyl carbonate, dipropyl carbonate, 1,2-dimethoxyethane, tetrahydrofuran, 2-methyltetrahydrofuran, 1,3-dioxolane, methyl acetate, and ethyl acetate. Among these, an electrolytic solution containing fluoroethylene carbonate is suitable because it tends to form a stable solid electrolyte interface (SEI) on a surface of the negative electrode material and significantly improves cycle characteristics.

A form of the lithium ion secondary battery is not particularly limited, and examples thereof include a paper type battery, a button type battery, a coin type battery, a laminate type battery, a cylindrical type battery, a prismatic battery, and the like. Furthermore, the negative electrode material for lithium ion secondary batteries can be applied not only to the lithium ion secondary batteries, but also to all electrochemical devices such as a hybrid capacitor having a charging and discharging mechanism of inserting and desorbing lithium ions.

### EXAMPLES

Hereinafter, the above-described embodiment will be described more specifically based on examples, but the above-described embodiments are not limited to the following examples.

(1) Preparation and Evaluation of Negative Electrode Material

Negative electrode material 1: Semi-needle coke (55 parts by mass) crushed to a volume average particle size of 15 μm, a tar pitch binder (25 parts by mass) having a softening point of 110° C., and SiC (20 parts by mass) as a catalyst were heated and kneaded at 130° C., which is a temperature equal to or higher than a temperature at which the binder dissolves, to obtain a mixture. Next, the obtained mixture was extrusion-molded to obtain a molded product. This molded product was heat-treated to a maximum temperature of 2,500° C. or higher such that it was graphitized. The graphitized product thus obtained was subjected to an isotropic secondary treatment, grinding, and sieving, and secondary graphite particles thus obtained having a volume average particle size of 20.0 μm were used for a negative electrode material 1.

Negative electrode material 2: Mosaic coke (40 parts by mass) having a volume average particle size of 17 μm, spheroidal graphite (20 parts by mass) having a volume average particle size of 22 μm, a tar pitch binder (18 parts by mass) having a softening point of 110° C., SiC (20 parts by mass) as a catalyst, and stearic acid (2 parts by mass) as a fluidity imparting agent were heated and kneaded at 130° C., which was higher than a temperature at which the binder dissolved, to obtain a mixture. Next, the obtained mixture was extrusion-molded to obtain a molded product. This molded product was heat-treated to a maximum temperature of 2,500° C. or higher such that it was graphitized. The graphitized product thus obtained was subjected to an isotropic secondary treatment, grinding, and sieving, and secondary graphite particles thus obtained having a volume average particle size of 23.0 μm were used for a negative electrode material 2.

Negative electrode material 3: Graphite secondary particles having a volume average particle size of 18.0 μm, which were produced in the same manner as the negative electrode material 2 except that a mosaic coke (40 parts by mass) having a volume average particle size of 12 μm, spheroidal graphite (20 parts by mass) having a volume average particle size of 16 μm, a tar pitch binder (18 parts by mass) having a softening point of 110° C., SiC (20 parts by mass) as a catalyst, and stearic acid (2 parts by mass) as a fluidity imparting agent were used.

Negative electrode material 4: Graphite secondary particles having a volume average particle size of 10.0 μm, which were produced in the same manner as the negative electrode material 2 except that a mosaic coke (40 parts by mass) having a volume average particle size of 6 μm, natural graphite (20 parts by mass) having an average particle size of 10 μm, a tar pitch binder (18 parts by mass) having a softening point of 110° C., SiC (20 parts by mass) as a catalyst, and stearic acid (2 parts by mass) as a fluidity imparting agent were used.

Negative electrode material 5: Graphite secondary particles having a volume average particle size of 20.0 μm, which were produced in the same manner as the negative electrode material 2 except that a mosaic coke (20 parts by mass) ground such that a volume average particle size became 17 μm, flake graphite (20 parts by mass) having a volume average particle size of 10 μm, spheroidal graphite (20 parts by mass) having a volume average particle size of 22 μm, a tar pitch binder (18 parts by mass) having a softening point of 110° C., SiO₂ (20 parts by mass) as a catalyst, and stearic acid (2 parts by mass) as a fluidity imparting agent were used.

Negative electrode material 6: Graphite secondary particles having a volume average particle size of 15.0 μm, which were produced in the same manner as the negative electrode material 2 except that a mixture obtained by heating and mixing, at 130° C., flake graphite (15 parts by mass) having a volume average particle size of 10 μm, spheroidal graphite (25 parts by mass) having a volume average particle size of 16 μm, a tar pitch binder (23 parts by mass) having a softening point of 110° C., and SiO₂ (20 parts by mass) as a catalyst, was mixed again with a ground powder obtained by crushing to a volume average particle size of 50 μm, stearic acid (2 parts by mass) as a fluidity imparting agent, and spheroidal graphite (25 parts by mass) having a volume average particle size of 16 μm to obtain a mixture.

Negative electrode material 7: A mixture (volume average particle size: 22.7 μm) of the negative electrode material 2 (70 parts by mass) and a negative electrode material C1 (30 parts by mass)

Negative electrode material 8: A mixture (volume average particle size: 22.5 μm) of the negative electrode material 2 (50 parts by mass) and a negative electrode material C6 (50 parts by mass)

Negative electrode material 9: A mixture (volume average particle size: 12.9 μm) of the negative electrode material 4 (50 parts by mass) and a negative electrode material C5 (50 parts by mass)

Negative Electrode Material 10: A mixture (volume average particle size: 18.2 μm) of the negative electrode material 2 (40 parts by mass), a negative electrode material C7 (50 parts by mass), and highly crystalline flake graphite particles (10 parts by mass) having a volume average particle size of 11 μm.

Negative Electrode Material 11: A mixture (volume average particle size: 12.2 μm) of the negative electrode material 2 (40 parts by mass), a negative electrode material C8 (50 parts by mass), and highly crystalline flake graphite particles (10 parts by mass) having a volume average particle size of 3 μm.

When scanning electron microscope (SEM) observation was performed on the negative electrode materials 1 to 11, it was found that a plurality of flat graphite particles contained particles in a state of being aggregated or bonded such that main surfaces thereof were not parallel to each other.

Negative electrode material C1: Graphite secondary particles graphitized at 2520° C. and having a volume average particle size of 22.1 μm, which were obtained by producing a mixture using (without a catalyst) a semi-needle coke (50 parts by mass) crushed to a volume average particle size of 17 μm, spheroidal graphite (25 parts by mass) having a volume average particle size of 22 μm, and a tar pitch binder (25 parts by mass) having a softening point of 110° C.

Negative electrode material C2: Graphite secondary particles having a volume average particle size of 18.7 μm, which were obtained by using a semi-needle coke (60 parts by mass) crushed to a volume average particle size of 15 μm, a tar pitch binder (30 parts by mass) having a softening point of 110° C., and SiO₂ (10) as a catalyst.

Negative electrode material C3: Flake graphite particles graphitized at 2,600° C. and having a volume average particle size of 18.5 μm, which were obtained by producing a mixture using (without a catalyst) a needle coke (70 parts by mass) crushed to a volume average particle size of 17 μm, and a tar pitch binder (30 parts by mass) having a softening point of 110° C.

Negative electrode material C4: Amorphous carbon coating of the negative electrode material 3

Negative electrode material C5: Spheroidal graphite having a volume average particle size of 15.0 μm

Negative electrode material C6: Spheroidal graphite having a volume average particle size of 23.0 μm

Negative electrode material C7: Spheroidal graphite having a volume average particle size of 16.0 μm (amorphous carbon coating)

Negative electrode material C8: Spheroidal graphite having a volume average particle size of 10.6 μm (amorphous carbon coating)

Negative electrode material C9: A mixture (volume average particle size: 16.0 μm) of the negative electrode material 4 (50 parts by mass) and the negative electrode material C2 (50 parts by mass)

Regarding the obtained negative electrode materials, a tap density (g/cm³), a post-pressurization density (g/cm³), an oil absorption capacity (ml/100 g), a degree of circularity and a specific surface area (m²/g), and an R value were measured under the above-mentioned conditions. The results are shown in Table 1.

(2) Production and Evaluation of Negative Electrode

Water was added to 98 parts by mass of the negative electrode material, 1 part by mass of styrene-butadiene rubber (BM-400B, manufactured by Zeon Corporation), and 1 part by mass of carboxymethyl cellulose (CMC2200, manufactured by Daicel Co., Ltd.), and the mixture was kneaded to produce a slurry having 55% by mass solid contents. This slurry was applied to a current collector (copper foil having a thickness of 10 μm), dried in air at 110° C. for 1 hour, and integrated by a roll press under conditions in which the applied substance (active substance) had a predetermined electrode density, and thereby a negative electrode was produced.

(3) Production and Evaluation of Cell for Evaluation

A charge capacity and a discharge capacity of the cell for evaluation produced using the produced negative electrode were measured, and an initial charge and discharge efficiency was calculated. With respect to the negative electrode having a density of 1.70 g/cm³, a discharge capacity after 40 cycles of charging and discharging was measured to calculate a discharge capacity retention rate. The results are shown in Table 1.

As the evaluation cell, a 2016 type coin cell was used, which was produced using the negative electrode obtained above, metallic lithium as a positive electrode, a mixed solution of ethylene carbonate/ethyl methyl carbonate (3/7 volume ratio) and vinylene carbonate (0.5% by mass) which contained 1.0 M LiPF₆ as an electrolyte solution, a polyethylene microporous membrane having a thickness of 25 μm as a separator, and a copper plate having a thickness of 230 μm as a spacer.

(Charge Capacity and Discharge Capacity)

Measurement of a charge and discharge capacity (initial charge and discharge capacity) was performed under conditions of sample mass: 15.4 mg; electrode area: 1.54 cm²; measurement temperature: 25° C.; electrode density: 1.70 g/cm³; charge conditions: constant current charge of 0.434 mA, constant voltage charge of 0 V (Li/Li⁺), and cut current of 0.043 mA; and discharge conditions: constant current discharge of 0.434 mA, cut voltage of 1.5 V (Li/Li⁺). A pause time (30 minutes) was provided when switching between charge and discharge. The discharge capacity was measured under the above charge and discharge conditions.

(Irreversible Capacity)

An irreversible capacity was obtained by subtracting the discharge capacity from the charge capacity.

(Initial Charge and Discharge Efficiency)

The initial efficiency was defined as a ratio (%) of a value of the discharge capacity (mAh/g) to a value of the measured charge capacity (mAh/g).

TABLE 1

| | | Examples | | | | | | | | | | |
|---|---|---|---|---|---|---|---|---|---|---|---|---|
| | | 1 | 2 | 3 | 4 | 5 | 6 | 7 | 8 | 9 | 10 | 11 |
| Negative electrode material | | 1 | 2 | 3 | 4 | 5 | 6 | 7 | 8 | 9 | 10 | 11 |
| Negative | Tap density | 0.82 | 0.92 | 0.79 | 0.72 | 0.90 | 0.95 | 0.93 | 0.97 | 0.85 | 0.99 | 0.86 |
| electrode | [g/cm³] | | | | | | | | | | | |
| material | Post-pressurization | 1.98 | 1.92 | 1.88 | 1.78 | 1.73 | 1.72 | 1.81 | 1.96 | 1.88 | 1.80 | 1.74 |
| characteristics | density [g/cm^{3]} | | | | | | | | | | | |
| | Oil absorption | 63 | 62 | 77 | 92 | 65 | 62 | 61 | 53 | 70 | 59 | 58 |
| | capacity [ml/100 g] | | | | | | | | | | | |
| | Degree of | 0.86 | 0.88 | 0.90 | 0.91 | 0.87 | 0.90 | 0.88 | 0.91 | 0.93 | 0.89 | 0.89 |
| | circularity [—] | | | | | | | | | | | |
| | Specific surface | 3.5 | 3.5 | 5.0 | 7.2 | 4.2 | 5.5 | 3.7 | 3.7 | 7.0 | 4.0 | 4.3 |
| | area [m²/g] | | | | | | | | | | | |
| | R value | 0.09 | 0.07 | 0.13 | 0.20 | 0.12 | 0.03 | 0.11 | 0.11 | 0.20 | 0.17 | 0.20 |
| Battery | Initial charge | 380 | 379 | 380 | 381 | 376 | 382 | 373 | 384 | 387 | 387 | 386 |
| characteristics | capacity [mAh/g] | | | | | | | | | | | |
| | Initial discharge | 355 | 358 | 357 | 356 | 350 | 358 | 349 | 360 | 358 | 359 | 359 |
| | capacity [mAh/g] | | | | | | | | | | | |
| | Irreversible | 25 | 21 | 22 | 24 | 26 | 24 | 24 | 24 | 28 | 28 | 27 |
| | capacity [mAh/g] | | | | | | | | | | | |
| | Initial charge and | 93.5 | 94.5 | 93.9 | 93.4 | 93.2 | 93.7 | 93.5 | 93.7 | 92.7 | 92.8 | 93.0 |
| | discharge efficiency | | | | | | | | | | | |
| | [%] | | | | | | | | | | | |

| | | Comparative Examples | | | | | | | | |
|---|---|---|---|---|---|---|---|---|---|---|
| | | 1 | 2 | 3 | 4 | 5 | 6 | 7 | 8 | 9 |
| Negative electrode material | | C1 | C2 | C3 | C4 | C5 | C6 | C7 | C8 | C9 |
| Negative | Tap density | 0.94 | 0.90 | 0.66 | 0.92 | 0.98 | 1.02 | 1.15 | 0.97 | 0.81 |
| electrode | [g/cm³] | | | | | | | | | |
| material | Post-pressurization | 1.55 | 1.62 | 1.57 | 1.55 | 1.98 | 2.00 | 1.65 | 1.55 | 1.69 |
| characteristics | density [g/cm^{3]} | | | | | | | | | |
| | Oil absorption | 58 | 61 | 74 | 70 | 48 | 46 | 48 | 55 | 77 |
| | capacity [ml/100 g] | | | | | | | | | |
| | Degree of | 0.89 | 0.91 | 0.82 | 0.92 | 0.95 | 0.94 | 0.93 | 0.91 | 0.91 |
| | circularity [—] | | | | | | | | | |
| | Specific surface | 4.2 | 3.6 | 7.4 | 2.8 | 6.7 | 5.5 | 3.2 | 4.0 | 5.4 |
| | area [m²/g] | | | | | | | | | |
| | R value | 0.19 | 0.08 | 0.10 | 0.27 | 0.23 | 0.21 | 0.26 | 0.35 | 0.14 |
| Battery | Initial charge | 357 | 379 | 379 | 386 | 395 | 392 | 391 | 389 | 380 |
| characteristics | capacity [mAh/g] | | | | | | | | | |
| | Initial discharge | 324 | 348 | 340 | 353 | 362 | 361 | 359 | 360 | 351 |
| | capacity [mAh/g] | | | | | | | | | |
| | Irreversible | 33 | 31 | 39 | 33 | 33 | 31 | 32 | 29 | 28 |
| | capacity [mAh/g] | | | | | | | | | |
| | Initial charge and | 90.8 | 91.9 | 89.8 | 91.5 | 91.6 | 92.1 | 91.8 | 92.5 | 92.4 |
| | discharge efficiency | | | | | | | | | |
| | [%] | | | | | | | | | |

As shown in the results of Table 1, in the lithium ion secondary batteries of Examples produced using the negative electrode material having the oil absorption capacity of 50 ml/100 g or more and the post-pressurization density of 1.70 g/cm³ or more, the evaluation of the initial charge and discharge efficiency was superior to that of the lithium ion secondary battery of Comparative Example produced using the negative electrode material that did not satisfy at least one of the above conditions. Furthermore, a value of the irreversible capacity was smaller than that of the lithium ion secondary battery of Comparative Example.

Based on the above results, it was found that it is possible to obtain a negative electrode material for lithium ion secondary batteries in which a favorable charge and discharge efficiency was maintained even in the case of densification, and an increase in irreversible capacity was inhibited, by using the negative electrode material having an oil absorption capacity of 50 ml/100 g or more and a post-pressurization density of 1.70 g/cm³ or more.

1. A negative electrode material for lithium ion secondary batteries, wherein an oil absorption capacity is 50 ml/100 g or more, and a post-pressurization density is 1.70 g/cm³ or more.

2. The negative electrode material for lithium ion secondary batteries according to claim 1, wherein the oil absorption capacity is 95 ml/100 g or less.

3. The negative electrode material for lithium ion secondary batteries according to claim 1, wherein the post-pressurization density is 1.98 g/cm³ or less.

4. The negative electrode material for lithium ion secondary batteries according to claim 1, wherein a specific surface area is 1.5 m²/g to 8.0 m²/g.

5. The negative electrode material for lithium ion secondary batteries according to claim 1, wherein a degree of circularity is 0.85 to 0.95.

6. The negative electrode material for lithium ion secondary batteries according to claim 1, wherein an R value from Raman measurement is 0.03 to 0.20.

7. The negative electrode material for lithium ion secondary batteries according to claim 1, wherein a tap density is 0.7 g/cm³ to 1.0 g/cm³.

8. The negative electrode material for lithium ion secondary batteries according to claim 1, comprising a plurality of flat graphite particles in a state of being aggregated or bonded such that main surfaces thereof are not parallel.

9. A negative electrode material slurry for lithium ion secondary batteries, comprising:
the negative electrode material for lithium ion secondary batteries according to claim 1;
an organic binding material; and
a solvent.

10. A negative electrode for lithium ion secondary batteries, comprising:
a current collector; and
a negative electrode material layer which contains the negative electrode material for lithium ion secondary batteries according to claim 1 and is formed on the current collector.

11. A lithium ion secondary battery comprising:
a positive electrode;
an electrolyte; and
the negative electrode for lithium ion secondary batteries according to claim 10.
